(19) United States
(12) Patent Application Publication
(10) Pub. No.: US 2009/0144176 A1
(43) Pub. Date: Jun. 4, 2009

(54) System and method for replicating objects from providers in communication displays from other providers

(75) Inventors: Jacques Voorhees, Dillon, CO (US); Todd Blanchard, Bainbridge Island, WA (US); Robert Arciere, Schnecksville, PA (US)

Correspondence Address: Oppedahl Patent Law Firm LLC, P.O. BOX 4850, FRISCO, CO, 80443-4850, US

(73) Assignee: POLYGROUP, LTD., Dillon, CO (US)

(21) Appl. No.: 12/325,902

(22) Filed: Dec. 1, 2008

Related U.S. Application Data
(63) Continuation of application No. 10/426,006, filed on Apr. 28, 2003.
Application No. 10/426,006 is a continuation of application No. 09/882,827, filed on Jun. 16, 2001, now abandoned.
Application No. 09/882,827 is a continuation of application No. PCT/US99/00052, filed on Jan. 4, 1999.
Application No. PCT/US99/00052 is a continuation of application No. 09/038,512, filed on Mar. 11, 1998, now abandoned.
Application No. 09/038,512 is a continuation of application No. 10/426,006, filed on Apr. 28, 2003.
Application No. 09/882,827 is a continuation of application No. 09/038,512, filed on Mar. 11, 1998, now abandoned.

(51) Int. Cl. G06Q 30/00

(52) U.S. Cl. 705/27; 705/26

(57) ABSTRACT

A communication system facilitates the replication of display objects from first providers into displays provided, upon request from subscribers, by second providers. The first providers may specify which second providers or classes of second providers may incorporate the replicated display objects, and which portions thereof the second providers may customize. The second providers may select which available replicates they will display, and may customize them as specified permissible by the first providers. Changes made to the objects become available immediately to subscribers.

### RELATED APPLICATIONS/CLAIM OF PRIORITY

This application is a continuation of U.S. application Ser. No. 10/426,006, filed on Apr. 28, 2003, incorporated herein by reference, which is a continuation of U.S. application Ser. No. 09/882,827, filed on Jun. 16, 2001, now abandoned, incorporated herein by reference, which is a continuation of PCT Application No. PCT/US99/0005219, filed on Mar. 10, 1999, incorporated herein by reference, which is a continuation of U.S. application Ser. No. 09/038,512, filed on Mar. 11, 1998, now abandoned, incorporated herein by reference. This application is also a continuation of U.S. application Ser. No. 10/426,006, filed on Apr. 28, 2003, incorporated herein by reference, which is a continuation of U.S. application Ser. No. 09/882,827, filed on Jun. 16, 2001, now abandoned, incorporated herein by reference, which is a continuation of U.S. application Ser. No. 09/038,512, filed on Mar. 11, 1998, now abandoned, incorporated herein by reference.

### FIELD OF THE INVENTION

The present invention relates to the dissemination by a digital communication network of information embodied in displays, and particularly to the replication of display objects from a first class of providers into displays of a second class of providers.

### BACKGROUND OF THE INVENTION

The dissemination over digital communication networks (such as the Internet) of information presented in the form of displays is well known. On the Internet there exists the World-Wide Web, wherein each source of information is displayed as a “web site,” or “web page”, and each web-site is identified by a “universal resource locator” (URL).

Techniques have been devised for visually correlating related displays of information. One such technique, known as “hypertext link”, consists of providing in a present display an icon or legend connoting a display that is related to the present display and which thus may be of interest to a user viewing the present display; if the user selects that icon or legend (as by clicking” on it with a pointing device, such as a “mouse”) the related display is automatically fetched for the user, and replaces the present display.

Although this provides some measure of convenience for the user, it is not seamlessly integrated inasmuch as it requires that the display he was viewing be erased and replaced with the new display; should he wish to make further use of the previous display he must find his way back to it; and, simultaneous viewing of the old and new displays is not possible.

These drawbacks can be more far-reaching if the information being disseminated involves product sales information. For example, if the user was viewing a display provided by a retailer, and if the icon he selected pertained to information provided by a supplier (wholesaler or manufacturer) about a product stocked by the retailer, it is to the retailer's detriment for the user to leave the retailer's display (web site) to go to the supplier's web site. The user may not find his way back, and the retailer may thus lose an opportunity for a sale.

Also under the hypertext link scheme, the display pertaining to product information (which display might typically be a supplier's web site) can have no provision for indicating unique aspects of a particular retailer's handling of those products, such as retail price, retailer's stock number, availability, 64 package deals”, and so forth.

To assist with this problem, a class of “web storefront software” has been developed (for example, “Store” from Viaweb, “Electronic Commerce Suite” from iCat) and is commercially available (see also U.S. Pat. No. 5,715,734); this software aids the retailer in creating “electronic storefront” websites which include product information provided by suppliers, thus reducing the need for a purchaser to switch from the retailer's web page to the supplier's. These programs facilitate the creation by a retailer of a database of information about the products available from suppliers. The more sophisticated of these packages permit “importing” product information from a database or spreadsheet provided by a supplier into the retailer's database, while the less sophisticated ones require product information to be manually transcribed into the user's database. Once the product information has thus been imported or transcribed into the retailer's web page, it can be customized to a particular retailer's situation.

This is not a “dynamic,” or “real-time” data distribution scheme, but a “batch” scheme; chances to product data do not automatically propagate to retailers, but reach a retailer only when the retailer next imports or transcribes the then-current information.

A drawback of this method is that chances made by a supplier to his product catalog will not be reflected in a retailer's web pages until the next-time that retailer carries out the import or transcription procedure, which the supplier is powerless to hasten. And, once a supplier releases product information he may have difficulty controlling which retailers carry it, the extent to which they modify it, and so forth.

### SUMMARY OF THE INVENTION

It is thus a general object of the present invention to provide improved dissemination of information.

It is a particular object of the present invention to provide improved dissemination over a communication network of information embodied in displays.

It is a more particular object of the present invention to facilitate the integration of information originating from multiple providers and transmitted over a communication network.

It is further particular object of the present invention to enable a first class of providers to provide display objects for incorporation into displays provided by a second class of providers.

It is a further particular object of the present invention to immediately disseminate new information to users of the second providers' displays as soon as such new information is entered by the first providers.

It is a further particular object of the present invention to allow the first providers immediate and continuing control over which second providers may carry first providers' display objects and how they modify the display objects.

The present invention overcomes the shortcomings of the prior art and meets the stated objects by introducing a system and method for first providers (such as product manufacturers) to provide display objects describing their products, and for second providers (such as retailers) to selectively incorporate replicates of those display objects into their own displays with the capability for the second provider to insert some of his unique information into the display object replicates.

These and other objects of the inventions will be clear to those skilled in the art after consulting the following description of the preferred embodiment, cast in the context of disseminating marketing information in the jewelry trade, and the appended drawings, wherein:

### BRIEF DESCRIPTION OF THE DRAWINGS

FIG. 1 depicts the system of the present invention.

FIG. 2 shows further detail of the contents of databases depicted in FIG. 1.

FIGS. 3A through 3C illustrate flow through the system of the present invention initiated by a customer requesting to see a retail jeweler's web page and requesting further information therefrom.

FIGS. 4A through 4D summarize at a high level the interaction facilitated by the present invention among a jewelry manufacturer, a retail jeweler, and a potential customer of the retail jeweler, and also show typical displays seen by the customer in response to that interaction.

FIGS. 5A-through SE depict a “command console” display presented to a retail jeweler to facilitate his altering the content and appearance of his web page.

FIGS. 6A through 6E depict a “command console” display presented to a manufacturer to facilitate his altering content and control information pertaining to his boutiques.

### DESCRIPTION OF A PREFERRED EMBODIMENT OF THE INVENTION

A preferred embodiment of the invention exists in, and will now be disclosed in, a context of disseminating via the Internet marketing information pertinent to the jewelry trade. However, those skilled in the art will contemplate the use of the invention to disseminate any type of information via any digital communication network.

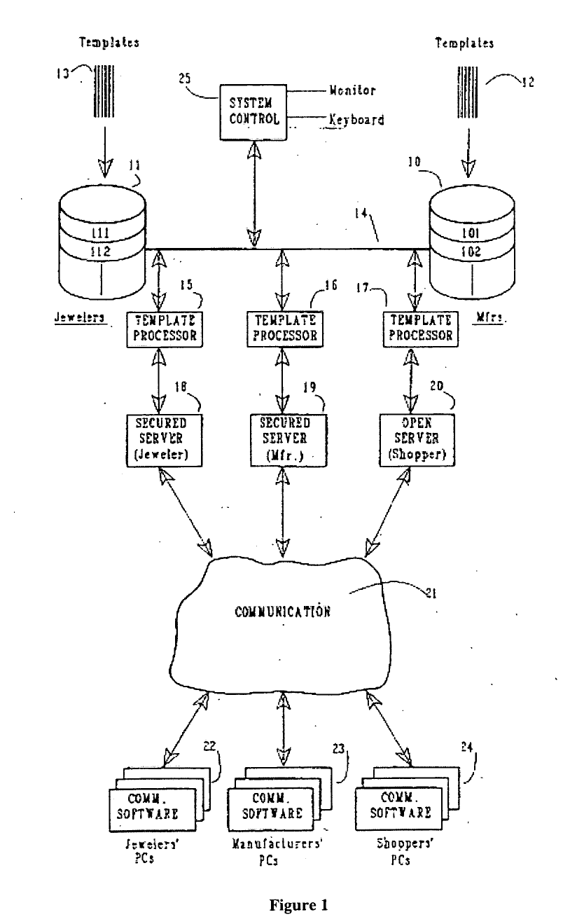

FIG. 1 illustrates the system of the present invention. A plurality of shoppers can access the system to view information provided by a plurality of retail jewelers acting in concert with a plurality of jewelry manufacturers. Each shopper, jeweler, or manufacturer has a personal computer (PC) (well known in the art and not shown) each equipped with communication software 22 Jewelers), 23 (manufacturers), and 24 (shoppers) for interfacing the PCs with the communication link 21.

In a present embodiment, communication link 21 is the Internet, but many other communication media may be contemplated for use in the present invention. Communication link 21 enables communication with servers 18, 19, and 20. In keeping with trends prevalent and well known in the communication arts to generate distributed systems, the servers 18, 19, and 20 may be associated with the same host computer or with different hotel computers. The path 14 may thus be internal to one host machine, or it may itself include a communications path among a number of host machines.

The information that is accessible to a shopper is determined jointly by templates 13 and database 11, associated with retail jewelers, and templates 12 and database 10, associated with jewelry manufacturers, and typically includes information in electronic form, including electronic advertising. The templates specify formats for respective portions of the information while the databases determine availability and content of the respective portions. The templates and database contents may be entered through system control unit 25, or by the jewelers and manufacturers from their PCs through their communication software 22 and 23 respectively.

A shopper who, through communication software 24, accesses the system of the present invention does so by directing his inquiry to a particular communication address—in the Internet-based implementation of the present embodiment he would enter the URL (using the well known HTTP protocol) of a particular jeweler's web site, which would cause communication link 21 to connect him to server 20, associated with a host machine with which the templates 13 and the jeweler's database 11 are also associated. Database 11 comprises datasets 111, 112, and so forth, one dataset for each particular jeweler accessible on the system. Similarly, there is a database 10 associated with manufacturers, and it includes datasets 101, 102, and so forth, one dataset for each manufacturer who wishes to be represented in the system.

The screen display that will be seen by the shopper in response to this inquiry is determined by the templates 13 and the particular jeweler's dataset, and may include display objects provided by manufacturers and determined by templates 12 and a manufactarer's dataset. Generally, the templates specify layouts (formats) which are filled in by content information specified in a dataset as directed by control information specified in a dataset, both found in the datasets within databases 10 and 11. The respective content information and control information may be entered by a system operator through system control unit 25, or it may be entered or modified by jewelers and manufacturers through communication software 22 and 23 respectively and forwarded through communication link 21.

Hierarchical levels of access privilege are contemplated, and it is desirable that some of the information be provided only through a central system control so that a jeweler or manufacturer is not able to capriciously raise his access level. On the other hand, some of the information can be changed at will by the jewelers and manufacturers, thus enhancing the flexibility of the system and the currency of information that may be seen by shoppers.

To respond to a shopper's request, under control of display processor information contained in templates 13 specifies the general format of a display screen for a jeweler, and the general format is “filled in” with information unique to the particular jeweler whom the shopper has requested, according to content information found in the dataset (such as the jeweler's name and address, for example) associated with that jeweler.

The content information may also specify that “virtual boutiques” may appear in the jeweler's display. (The display objects that may be provided by manufacturers for displaying the manufacturer's wares within the jeweler's web page are analogous to the manufacturer's “boutiques” or “kiosks” often found in actual jewelry stores, and for that reason are sometimes referred to herein as “virtual boutiques” or simply as “boutiques”.)

The jeweler's dataset contains information about whether a particular manufacturer's boutique is to be shown and attributes specifying how the jeweler wishes it to be shown, while the manufacturer's templates 12 as filled in according to the manufacturer's dataset specify the content of the boutique. The manufacturer's dataset also includes control information which specifies such things as whether the particular jeweler is permitted to carry the boutique.

Replicating a boutique from the manufacturer's database 10 into a display being made up by display processor 17 largely from jeweler's database 11 requires data transmission over path 14, which, as previously mentioned may be a hard path within a single host machine or a communications link between two host machines.

As is known to those in the art, database 11 may or may not be implemented as an object-oriented database. If it is object-oriented, it will have instructions embedded in it and will initiate on its own a request over path 14 for the requisite information from database 10, and will provide all the information necessary for a display to display processor 17. If it is not object-oriented, display processor 17 will have to initiate requests for such information over path 14, and display processor 17 will be responsible for assembling information for a complete display from database 10 and database 11.

Display processor 17 forwards the display information through server 20 and over communication link 21 to the shopper's communication software 24 which presents the shopper with the indicated display on his monitor.

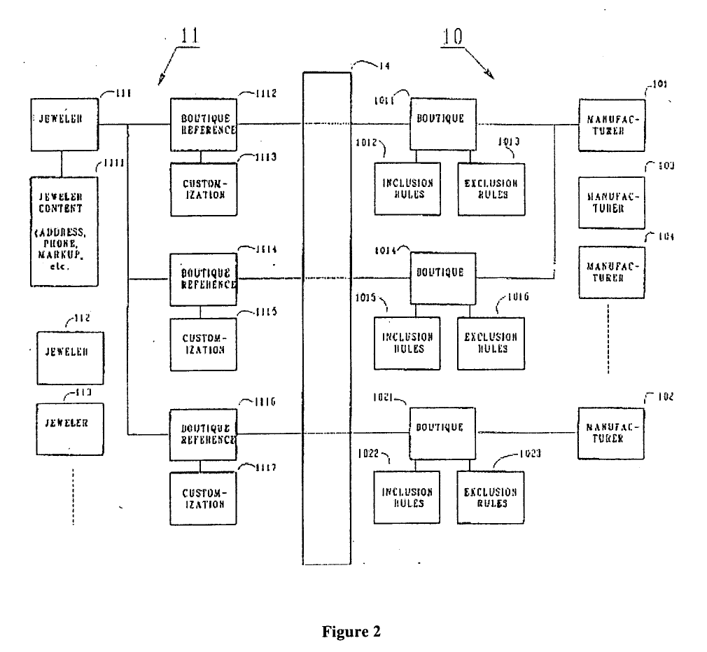

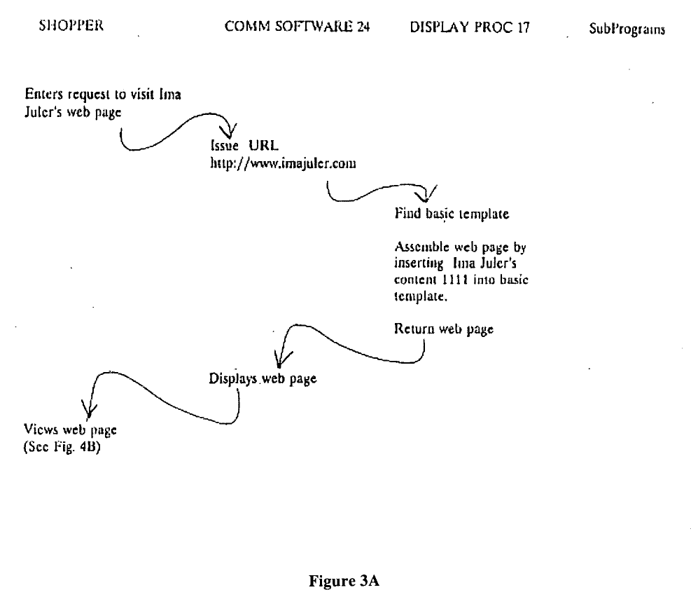

Further detail of databases 10 and 11 is shown in FIG. 2. FIG. 2 is seen to include the path 14 also shown in FIG. 1. Databases 10 and 11 are seen to be connected to path 14. As was shown in FIG. 1, system control 25 and display processors 15, 16, and 17 also have connection to path 14 although they are not shown in FIG. 2; through path 14, system control 25 and display processors 15, 16, and 17 have access to databases 10 and 11.

Database 11 has a dataset for each retail jeweler 111, 112, 113, etc. who may have a web page under the present embodiment; although that number is virtually unlimited, only one jeweler's dataset (111) is shown in detail in FIG. 2, and is seen to include content information 1111, three boutique references 1112, 1114, and 1116, and customization information 1113, 1115, and 1117 associated with the respective boutique references.

The jeweler's content 1111 includes items that may be filled on his templates 12 (not shown in FIG. 2) to appear on his web page, such as his address and phone number, and may also include items such as his markup, affiliations and memberships, etc.

Jeweler 111 may carry or offer a number of boutiques on his web page, and in the present example is carrying three, with a reference to each in his dataset (1112, 1114, and 1116). These references are to boutiques 1011 and 1014 associated with manufacturer 101, and boutique 1021 associated with manufacturer 102, now to be discussed in connection with database 10.

Database 10 has a dataset for each manufacturer 101, 102, 103, 104, etc. who may provide display objects (boutiques) to be replicated into retail jewelers' web pages. The number of manufacturers is virtually unlimited; FIG. 2 shows detail of datasets for but two of them, 101 and 102. Boutiques (e.g., 1011) are shown for each of these manufacturers; although each manufacturer may have any number of boutiques, FIG. 2 only depicts those earned by jeweler 111.

The datasets for jewelers other than jeweler 111 may contain references to some or all of the same boutiques as jeweler 111, and as well to other boutiques of those manufacturers and to the boutiques of other manufacturers.

Associated with each boutique in database 10 is a set of inclusion rules and a set of exclusion rules; for example, associated with boutique 1011 are inclusion rules 1012 and exclusion rules 1013. It is through these sets of rules that a manufacturer has control over which retailers may carry the boutique and which portions of the boutique they may customize. That a jeweler has a reference to a boutique does not of itself ensure that he will display the boutique; the corresponding inclusion rules must permit him to carry it, and the exclusion rules must not prohibit him from carrying it. At their simplest, these lists may entail specific identifications of retail jewelers allowed to carry (in inclusion rules) or prohibited from carrying (in exclusion rules) the boutique. The specific identifications may be by name, or by some other means such as an identification number.

Inclusion or exclusion of retail jewelers may be expressed in other ways as well; for example, the jeweler's membership in certain trade associations, his geographical location, his credit rating, etc.

Since jeweler 111's dataset contains boutique reference 1112 to boutique 1011, and since in the present example inclusion rules 1012 grant permission for jeweler 111 to carry the boutique and exclusion rules 1013 do not prohibit jeweler 111 from carrying the boutique, when a potential purchaser visiting jeweler 111's web page requests to see boutique 1011 (typically by clicking an icon or legend) an HTML description of the boutique is retrieved over path 14 by display processor 17 (reference should now be made to FIGS. 1 and 2 in conjunction) from templates 12 and HTML content information contained in boutique 1011. The HTML description is passed by path 14 to display processor 17. Display processor 17 has already assembled and sent to shopper 24 the basic web page for jeweler 111, and will now assemble and replicate into that web page the boutique specified by 1011. The HTML description received over path 14 may contain specifications that some of the information in the display object is subject to modification by the retail jeweler. This modification will be performed according to criteria specified in the customization list associated with the boutique reference, in this case 1113. Typically, an identification of the boutique will appear in the display object and will not be specified as modifiable by the retail jeweler. Fields that typically are modifiable are the prices of items (to be adjusted according to the retailer's markup), SKU numbers (stock-keeping unit numbers, well known in retailing and related to UPC (universal price code) methodology), the names and descriptions associated with items, etc.

After making these modifications in the manufacturer's display object, the object is forwarded through server 20 and communication link 21 to shopper 24 where it appears incorporated in the retailer's web page.

Those skilled in the art will appreciate that under this scheme, changes made by the manufacturer to his boutique description (such as 1011) take effect immediately—all shoppers requesting the boutique after such a change will see the new information. This is in marked contrast with the storefront software of the prior art, in which such changes are not seen on a retailer's web page until such time as that retailer next performs an import or a manual transcription of the new information. Numerous cases are known of web pages that are many weeks, and even months, out of date. Similarly, changes to inclusion rules 1012 and exclusion rules 1013 take effect immediately.

This ability to display completely current information on the web pages of a great many retail jewelers is highly beneficial to a manufacturer compared to having a single website of his own. It is also beneficial to the jeweler to be able to showcase products from various manufacturers on his own website, under his own name, and with his own particulars.

Yet, a separation of concerns is observed—a manufacturer may choose what jewelers may carry his display objects and what contents of them a jeweler may change, and a jeweler, may choose to carry or not to carry any of the boutiques a manufacturer makes available to him, and to enter contents of his choice into the fields the manufacturer has approved for such changes.

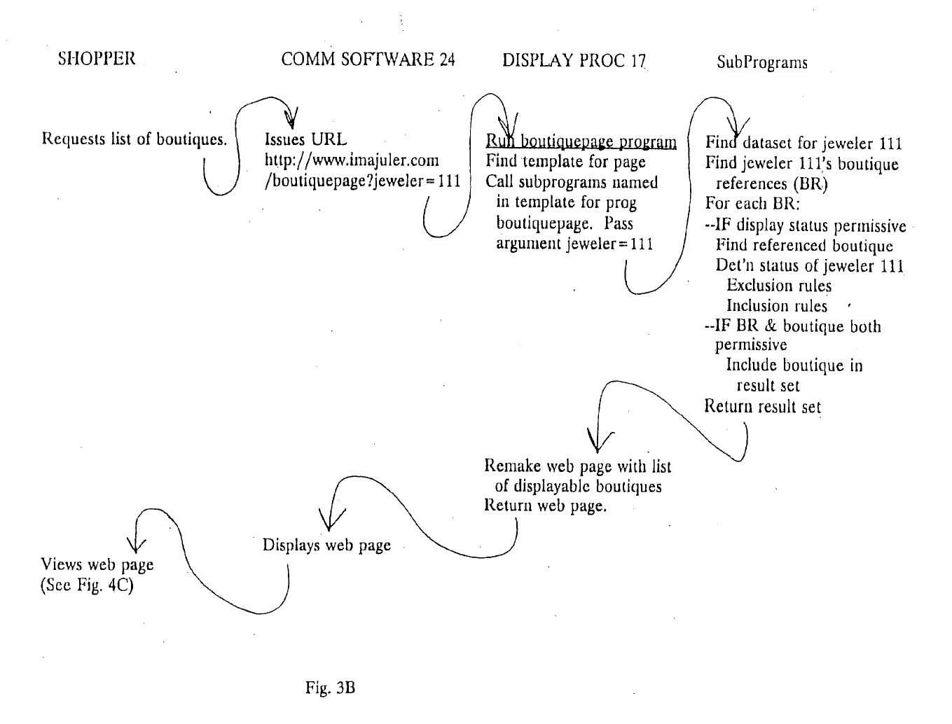

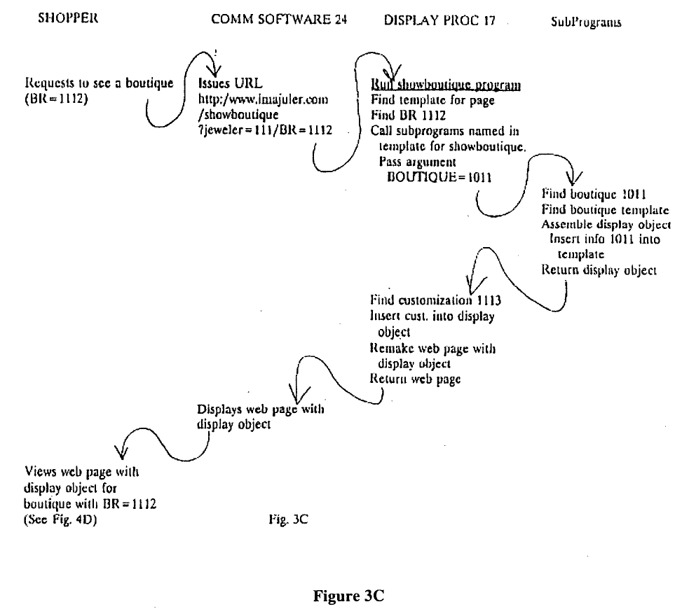

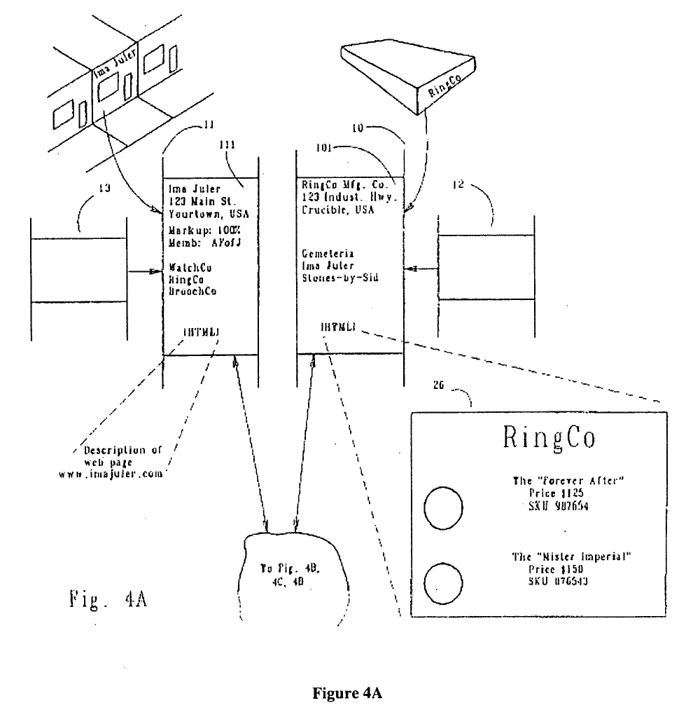

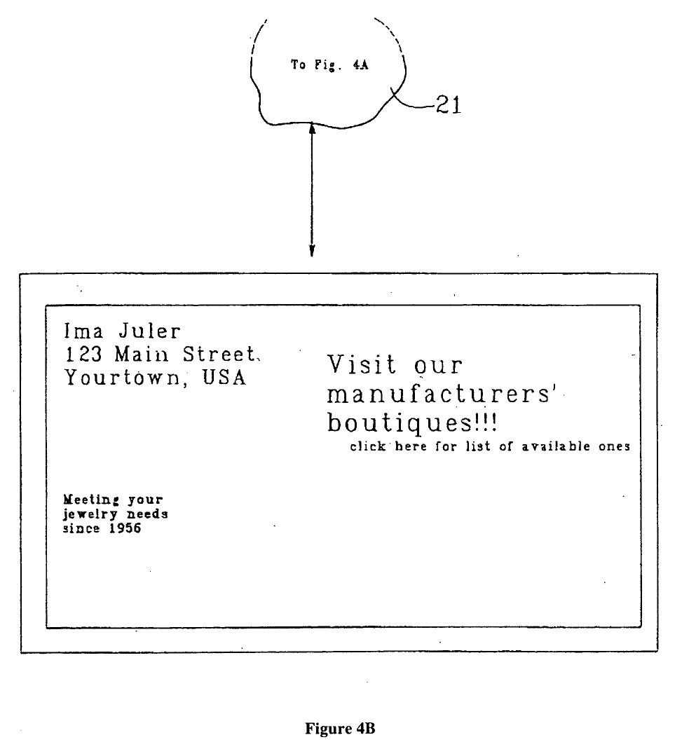

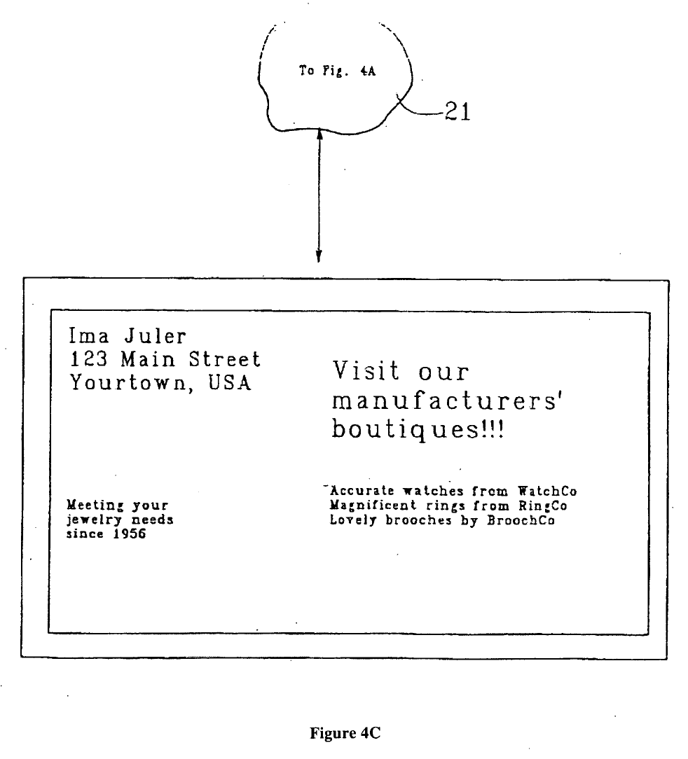

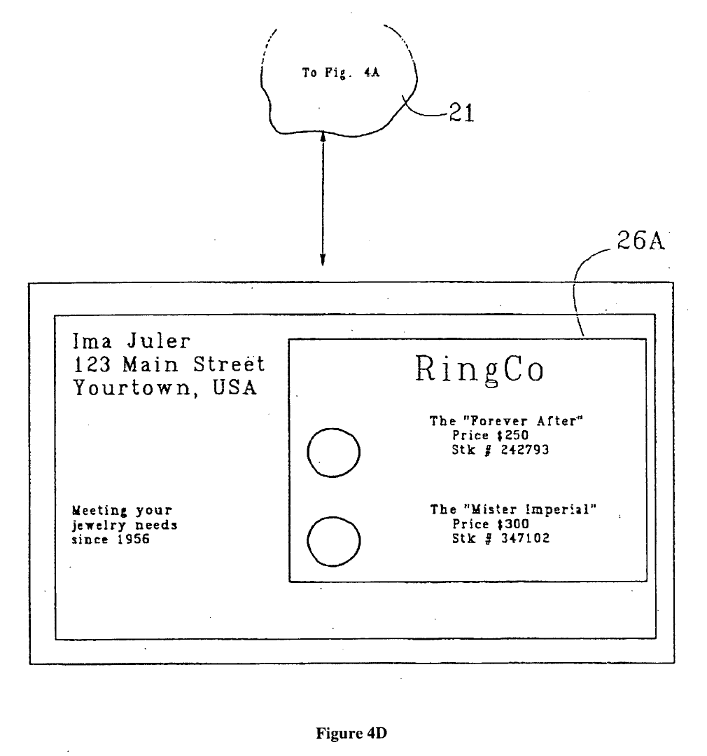

A flow through the system of the present invention is illustrated in FIGS. 3A, 3B, and 3C. FIG. 4A shows schematically and at a high level the interaction provided by the present invention among a retail jeweler, a jewelry manufacturer, and a prospective customer of the retail jeweler;

FIGS. 4B) 4C, and 4D depict a series of displays that might appear on the shopper's monitor as a result of this interaction.

It is seen at a high level in FIG. 4A that a local jeweler (for ease of description named “Ima Juler”) has a dataset 111 in database 11. It contains his name and address; the markup (100%) that he wishes to apply to wholesale prices; an indication that he is a member of the American Federation of Jewelers (AFofJ); references to manufacturers' boutiques he wishes to display; and a description in HTML (hypertext markup language, well known in the art) of the web page he wishes shoppers to see.

Similarly, it is seen at a high level in FIG. 4A that a ring manufacturer (for ease of description named “RingCo”) has a dataset 101 in database 10. It contains RincCo's name and address, a list of retail jeweler's permitted to carry their boutique, and an HTML description of their boutique. The boutique as specified by that HTML is shown as element 26.

In FIG. 3A, a shopper who lives in the vicinity of Ima Juler's store and who is contemplating the purchase of a ring enters at his PC a request to visit Ima Juler's web page, causing his communication software 24 (FIG. 1) to issue Ima Juler's URL, typically of the form

http://www.imajuler.com

That URL is forwarded to communications link 21 (the Internet in the present embodiment, not shown in FIG. 3A) which forwards it to server 20 (also not shown in FIG. 3A) where it causes the invocation of display processor program 17.

Reference should now be had to FIG. 2 along with FIG. 3A. Display processor 17 accesses database 11 and templates 13 by means of path 14. It will be recalled that since the computer equipments supporting the present invention may be in the form of a distributed system, this usage of path 14 may be over a hard path within a single machine, or over a communication link between machines. The determination of which kind of path access to perform may be performed by instructions within the programs comprising display processor 17, or by instructions embedded within data references if display processor 17 is “object oriented”.

Display processor 17 finds among templates 13 the basic template for a local jeweler's web page, and assemble's jeweler 111's basic web page by filling in the template with the local jeweler 111's content information 1111. The web page is returned over the Internet 21 to communication software 24, which causes it to display on the monitor associated with, the shopper's PC. The shopper may then view it. A typical example is seen in FIG. 4B.

It is seen in FIG. 4B that the shopper is invited to visit manufacturer's boutiques. He may now request a list of available boutiques by clicking on the appropriate legend in FIG. 4B. When he does so (referring now to FIG. 3B), his communication software 24 issues to the Internet a URL of the form

http://server_id/program_name?parameters

which in the present case might specifically be

http://www.imajuler.com/boutiquepage?jeweler=111

This reaches server 20 according to the server id of www.imajuler.com. Server 20 invokes display processor 17 which is instructed by the URL to run a particular one of its constituent programs, a program named “boutiquepage”, which is called with a parameter of “jeweler=11”.

Program boutiquepage locates in templates 13 the template required for the page requested by the shopper. A feature of templates is that they may contain the names of subprograms, including subprograms required for their own filling in. Display processor 17 contains the subprograms and, upon finding the subprogram names in the template, calls the specified subprograms, passing them the argument “jeweler=111.

The subprograms called in this case query the dataset for jeweler 111, and find his boutique references (BR). For each boutique reference, it is determined whether the retail jeweler has specified whether he wishes to display the referenced boutique. If so, the corresponding boutique is located via path 14, and it is determined whether the manufacturer wishes the current particular jeweler to carry the boutique. That is, the inclusion rules are checked to verify that the retail jeweler is specified in them, and the exclusion rules are checked to ascertain that the retail jeweler is not specified in them. For example, the inclusion rules might specify that all members of a particular trade association are included, but the exclusion rules may exclude particular jewelers despite their membership in the trade association, for such reasons as credit rating, unfavorable transaction history, and so forth if the jeweler's boutique reference and the manufacturer's boutique both indicate that the jeweler is permitted to display the referenced boutique, the boutique name is included in the result set. After all boutique references have been thus processed by the subprograms, the result set is returned to program boutiquepage.

According to the current template and the result set, a new display page containing the list of available boutiques is made up and returned via communication link 21 to the shopper's communication software 24. It is displayed to the shopper, who views it. A typical example is shown in FIG. 4C.

Referring now to FIG. 3C, the shopper requests to view a particular one of the available boutiques. He does so typically by clicking on the name of a desired boutique. Since he is contemplating the purchase of a ring, he selects the boutique “Magnificent rings from RingCo” (FIG. 4C). Transparently to the shopper, his request is transmitted with a program name invocation of “showboutique” and a parameter indicating the boutique reference, such as 1112.

The request reaches display processor 17 which runs its constituent program showboutique, which finds in templates 13 the appropriate template for the page, and also finds the boutique reference 1112, from which it can be determined that the requested boutique is 1011. Constituent subprograms of display processor 17 as named in the retrieved template are called with an argument specifying boutique 1011. Over path 14, they find information 1011 specifying the display object (boutique), and they find the template from templates 12 specifying the form or layout of the boutique. The template is filled in according to information 1011, thus producing a copy of the requested display object, which is returned to program show boutique. Showboutique then, either internally or through the invocation of other subprograms, finds the retail jeweler's customization information associated with the boutique reference (in this case customization information 1113 associated with boutique reference 1112) and incorporates the customization information into the display object.

A web page is assembled including the requested display object (boutique) and returned via communication link 21 to the shopper's communication software 24, which causes it to be displayed to the shopper who now views it. A typical example is shown as element 26A in FIG. 4D. Although element 26A has the same general layout as element 26 in FIG. 4A, some items in it are seen to be different. This is a result of the aforementioned customization. The prices specified by RingCo's HTML description in element 26 are wholesale prices; after applying Ima Juler's customization with his markup of 100%, the prices shown in element 26A are twice those shown in element 26. Similarly, where element 26 shows SKU numbers, element 26A shows different “stock numbers”. This conversion could be specified by Ima Juler in order to prevent the shopper from learning the true SKU number which might facilitate the shopper's “shopping around” for the item, which might be detrimental to Ima Juler.

Thus, the shopper is able to see the manufacturer's information without leaving the retail jeweler's web page, including all updates made by the manufacturer. And, the shopper sees the retail jeweler's customization of the manufacturer's information. These factors in conjunction facilitate a satisfying purchase for the customer, a sale for the jeweler, and a sale for the manufacturer.

If the manufacturer or the jeweler wish to change their content information or their control information, they can do so from their PC's (not shown) through their communication software 23 and 22 respectively. Note on FIG. 1 that servers 18 and 19 (which the jeweler or manufacturer respectively would reach, typically by accessing the associated URLS) may possibly be secured servers, whereas server 20 for the use of shoppers is always an open server. The jeweler or manufacturer may thus be required to demonstrate access privilege in order to be accepted by the servers, typically by entering predetermined passwords as is well known in the art.

In the present embodiment, they are then shown “command console” displays facilitating their manipulation of their information.

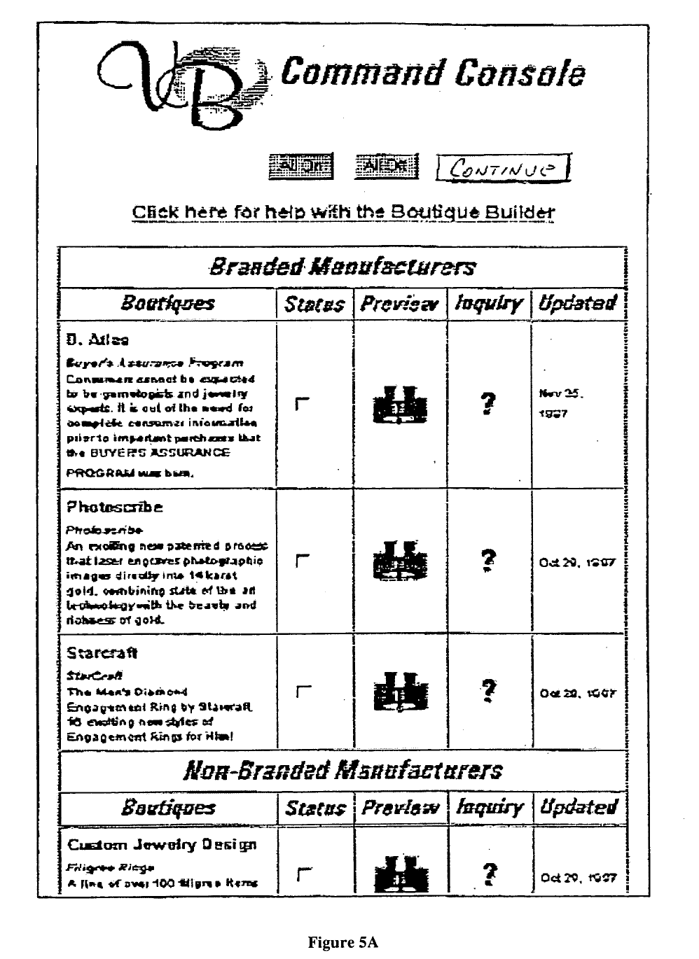

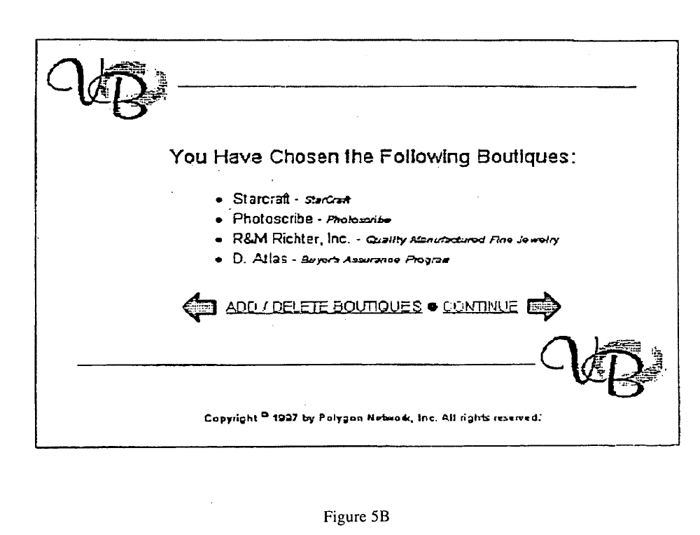

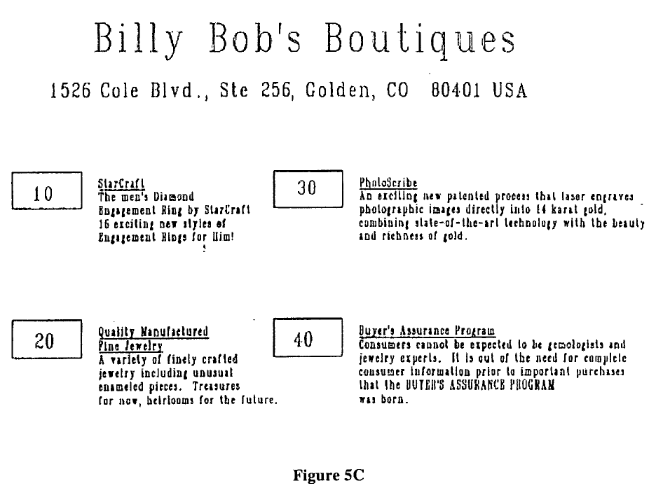

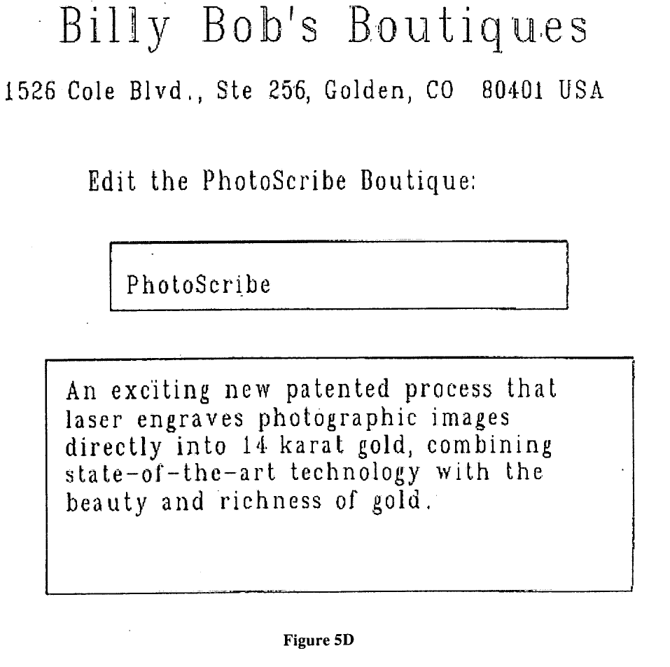

FIGS. 5A through 5E show the screens provided to a retail jeweler to facilitate his maintaining the boutiques in his web page.

On first accessing server 18 (of FIG. 1) and entering his password (if required), the jeweler is shown a screen like that of which FIG. 5A is representative. Boutiques offered by manufacturers are listed, categorized as being from “Branded” or “Non-Branded” manufacturers. Some may have a symbol (such as a circle with a line through it, not shown) indicating that the jeweler is not presently permitted to carry the boutique, though he may preview it and inquire about it as mentioned below. There may be more to display than can fit on his screen at once; by means well known in the art he may have to “scroll’ vertically to view listings of all available boutiques.

He can click on the Inquiry column for a boutique and be shown information, for example, on the requirements for making the boutique available to him.

He can click on the Preview column for a boutique and he will then see what the boutique would look like on his web page as seen by one of his customers.

He can click the Status column and be shown a screen on which he may, among other things, select whether an available boutique will or will not be carried on his web page.

After he makes his desired inquiries and selections he may click on the Continue button, whereupon he is shown a screen like that of FIG. 5B. He is shown a list of the boutiques he has selected; if the list is not satisfactory he can click on “ADD/DELETE BOUTIQUES” and be returned to the screen of FIG. 5A; if the list is satisfactory he can click on “CONTINUE” and proceed to a screen like that of FIG. 5C.

In the screen of FIG. 5C each boutique is seen to be associated with an input box containing a number; boutiques will be displayed in the order of these numbers. He can click these boxes and enter new numbers in them so that the order of numbers reflects his desired order of display.

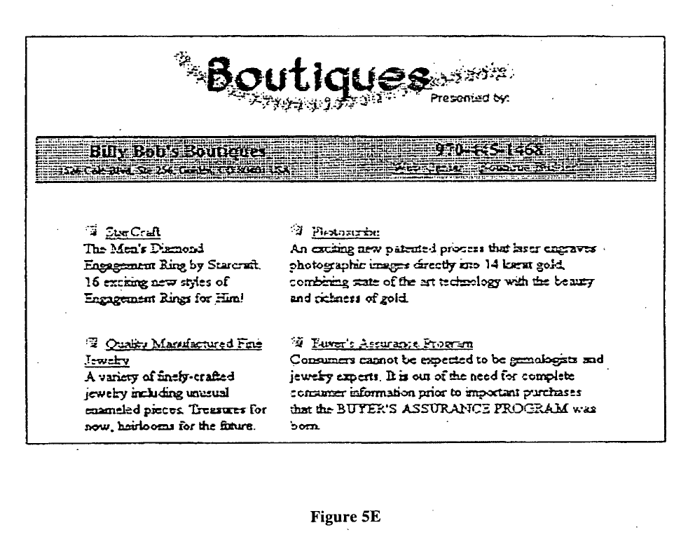

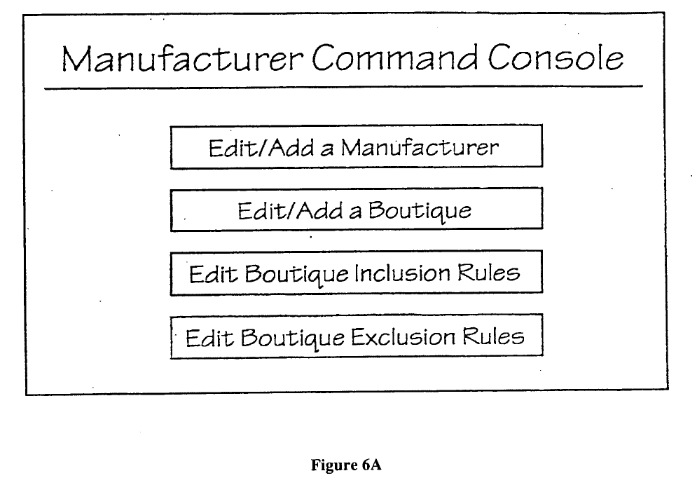

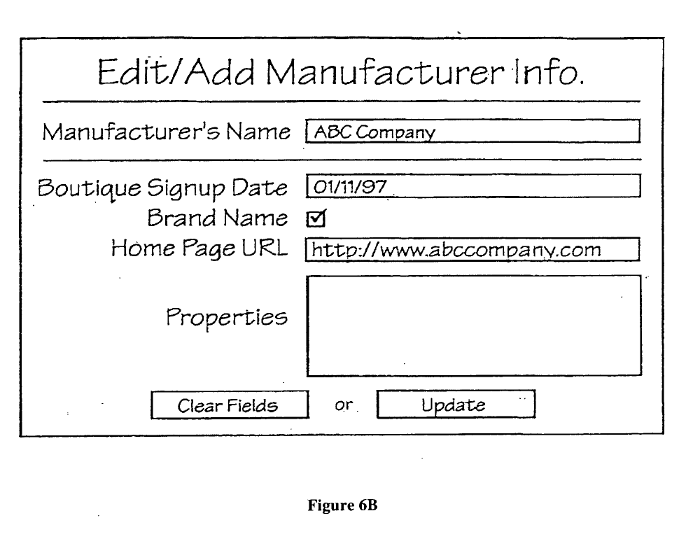

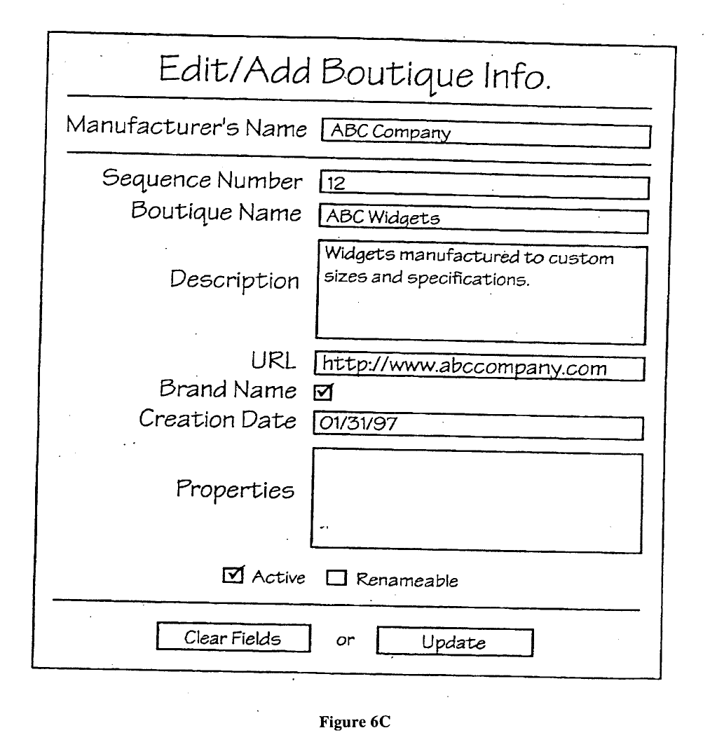

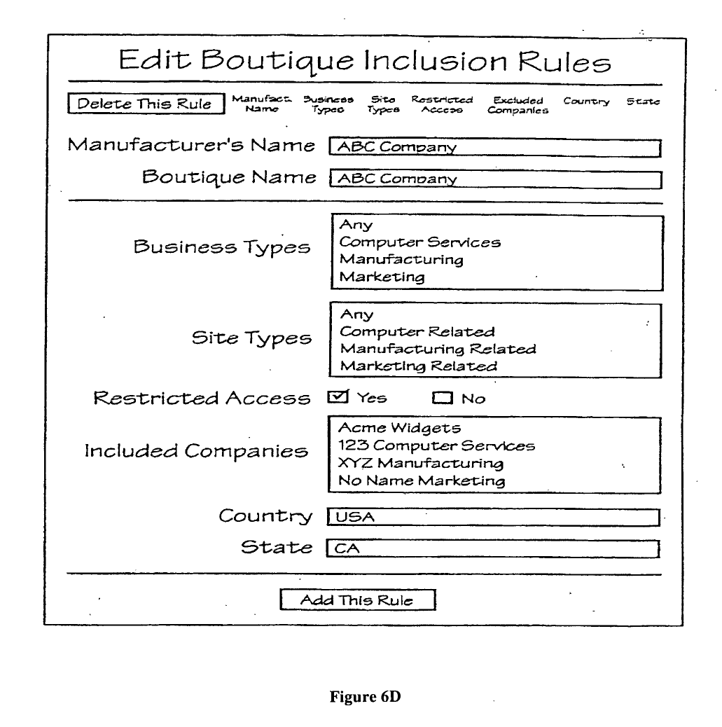

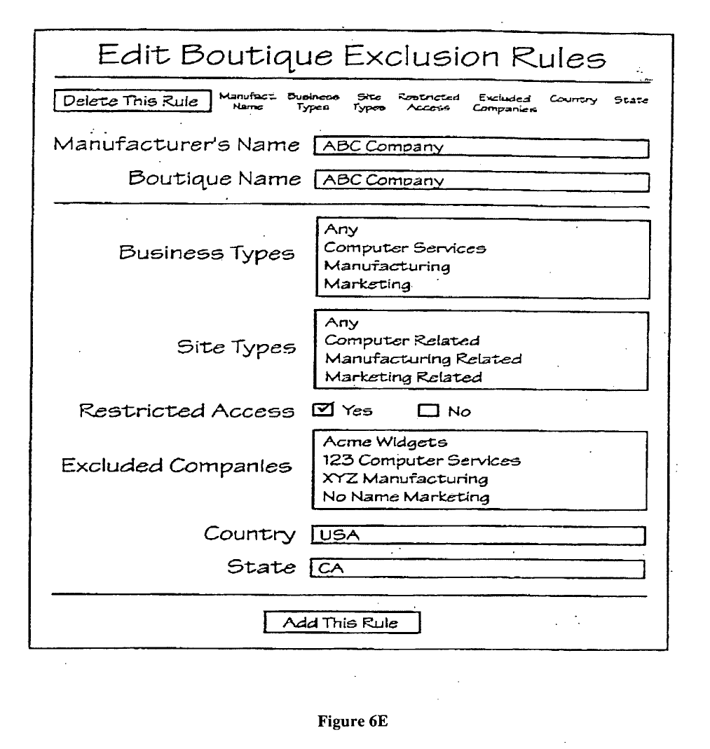

If he wishes to alter the title or text associated with a boutique (and if he has permission to change them as by the manufacturer having checked the “RENAMABLE” checkbox as shown in FIG. 6C to be discussed below) he clicks on the boutique name. For example, if the clicks on the link “PhotoScribe”, he is shown a screen as in FIG. 5D, which has a box containing the boutique name and another box containing the text; clicking on either of these enters a mode, as is known in the art, where these items may be edited.

Upon returning from the screens of FIGS. 5C and 5D he has the option (by clicking a PREVIEW button, not shown) to see a screen like that of FIG. 5E, which is a preview of what his boutique selection page, as presented to his retail customers, will look like. FIG. 5E is thus analogous to FIG. 4C, which contains different exemplary matter and was previously discussed in a different connection.

FIGS. 6A through 6E show a series of screens that would be shown to a manufacturer to enable him to maintain and edit the boutiques that are to be carried by retail jewelers. Upon entering the server 19 (of FIG. 1) and validating with his password, he is shown a screen like that of FIG. 6A.

If he clicks on “Edit/Add a Manufacturer” he is shown a screen like that of FIG. 6B, where he may edit his company name as it will appear in his boutiques, whether his boutiques will be listed as “branded” or “non-branded” (see FIG. 5A) and various other information. The “Properties” block is provided as a catch-all programming mechanism in which various parameters may be presented for information or for the insertion of values.

If from the screen of FIG. 6A the manufacturer selects “Edit/Add a Boutique” he is shown a screen like that of FIG. 6C, where he can enter various information descriptive or controlling of a boutique.

If from the screen of FIG. 6A the manufacturer selects “Edit Boutique Inclusions Rules”, he is shown a screen like that of FIG. 6D. Here he may enter such things as predetermined business types that carry the boutique, and predetermined site types that may carry it. It may be limited to sites in a particular country, and to a particular state. Additionally, certain named companies can be permitted to carry the boutique even if they do not fall within any of the named categories such as site type or business type.

If from the screen of FIG. 6A the manufacturer selects “Edit Boutique Exclusion Rules”, he is shown a screen like that of FIG. 6E, which exemplarily shows much of the same contents as the screen of FIG. 6D The inclusions of FIG. 6D and LOGICAL NOT'd with the exclusions of FIG. 6E. For an inclusion to be effected, a condition must appear in the inclusions and must not appear in the exclusions. (If FIGS. 6D and 6E were used in actual practice, there would, in effect, be no inclusions—no jeweler would be permitted to carry the ABC Company boutique.)

Since modifications and changes varied to fit particular requirements and environments will be apparent to those skilled in the art, the invention is not limited to the embodiments set forth or suggested herein. It is to be understood that the invention is not limited thereby. It is also to be understood that the specific details shown are merely illustrative, and that the invention may be carried out in other ways without departing from the broad spirit and scope of the specification.

1. A method for use with a system comprising a server and a database, the database containing first control information, first content information, second control information, and second content information, the method comprising the steps of:
receiving a request from a first user indicative of a first retailer;
retrieving first control information relating to the first retailer and indicative of at least first and second manufacturers;
for each of the at least first and second manufacturers, retrieving second control information relating to the respective manufacturer that is indicative of whether second content information regarding the respective manufacturer is allowed to be displayed by the first retailer;
transmitting second content information regarding each of the at least first and second manufacturers to the first user in the event that the second control information relating to the respective manufacturer indicates that second content information regarding the respective manufacturer is allowed to be displayed by the first retailer; and
transmitting information formatted according to first control information relating to the first retailer.

2. Server apparatus comprising:
at least one database storing first control information items associated with respective retailers, first content information items associated with respective retailers, second control information items associated with respective manufacturers, and second content information items associated with respective manufacturers,
means responsive to a request from a first one of the respective retailers to modify items of the first control information, and for modifying said items of the first control information only if said items of the first control information are associated with the first one of the respective retailers;
means responsive to a request from a first one of the respective manufacturers to modify items of the second control information, and for modifying said items of the second control information only if said items of the second control information are associated with the first one of the respective retailers;
means responsive to a request from a first one of the respective retailers to modify items of the first content information, and for modifying said items of the first content information only if said items of the first content information are associated with the first one of the respective retailers;
means responsive to a request from a first one of the respective manufacturers to modify items of the second content information, and for modifying said items of the second content information only if said items of the second content information are associated with the first one of the respective manufacturers; and
means responsive to a request for information from a first user indicative of a first retailer, for retrieving first control information relating to the first retailer and indicative of at least first and second manufacturers, for each of the at least first and second manufacturers, for retrieving second control information relating to the respective manufacturer that is indicative of whether second content information regarding the respective manufacturer is allowed to be displayed in connection with the first retailer, and for transmitting second content information regarding each of the at least first and second manufacturers to the first user in the event that the second control information relating to the respective manufacturer indicates that second content information regarding the respective manufacturer is allowed to be displayed in connection with the first retailer; the transmitted information formatted according to first content information relating to the first retailer.

3. A system for enabling one or more shoppers to access information provided by a plurality of retailers acting in concert with a plurality of manufacturers over a computer network, comprising:
one or more host machines connected with said computer network;
a first control information and a first content information associated with each of said plurality of retailers and stored on at least one of said one or more host machines;
a second control information and a second content information associated with each of said plurality of manufacturers and stored on at least one of said one or more host machines;
at least one shopper's computer with communications software available to one or more of the shoppers, said shopper's computer being able to connect to said computer network; and
a display processor program (DPP) resident on said one or more host machines for receiving a request from at least one of the plurality of shoppers to display information from at least one of the plurality of retailers according to data stored in the first control information, the first content information, the second control information, and the second content information, the information displayed including information specified by the at least one of the plurality of retailers and further including a replicate of a display object specified by at least one of said plurality of manufacturers as qualified according to the first control information and the second control information.

4. The system of claim 3, further comprising:
a system control machine operatively connected to the one or more host machines, wherein said system control machine can be used to enter and/or modify any of the first control information, the first content information, the second control information, and the second content information.

5. The system of claim 3, further comprising:
a command console program (CCP) resident on said one or more host machines for allowing each of said plurality of retailers and each of said plurality of manufacturers to enter and/or modify the first control information and the first content information or the second control information and the second content information that is associated with each of said plurality of retailers and each of said plurality of manufacturers;
at least one retailer's computer with communication software available to each of said plurality of retailers, said retailer's computer being able to connect to said computer network through which connection can be made to said one or more host machines to access the CCP; and
at least one manufacturer's computer with communications software available to each of said plurality of manufacturers, said manufacturer's computer being able to connect to said computer network through which connection can be made to said one or more host machines to access the CCP.

6. A system for enabling a shopper to access information provided by a retailer acting in concert with a manufacturer over a computer network, comprising:
one or more host machines connected with said computer network;
a first control information and a first content information associated with the retailer and stored on at least one of said one or more host machines;
a second control information and a second content information associated with the manufacturer and stored on at least one of said one or more host machines;
at least one shopper's computer with communications software available to the shopper, said shopper's computer being able to connect to said computer network; and
a display processor program (DPP) resident on said one or more host machines for receiving a request from the shopper to display information from the retailer according to data stored in the first control information, the first content information, the second control information, and the second content information, the information displayed including information specified by the retailer and further including a replicate of a display object specified by the manufacturer as qualified according to the first control information and the second control information.

7. The system of claim 6, further comprising:
a system control machine operatively connected to the one or more host machines, wherein said system control machine can be used to enter and/or modify any of the first control information, the first content information, the second control information, and the second content information.

8. The system of claim 6, further comprising:
a command console program (CCP) resident on said one or more host machines for allowing the retailer and the manufacturer to enter and/or modify the first control information and the first content information or the second control information and the second content information that is associated with the retailer or the manufacturer;
at least one retailer's computer with communications software available to the retailer, said retailer's computer being able to connect to said computer network through which connection can be made to said one or more host machines to access the CCP; and
at least one manufacturer's computer with communications software available to the manufacturer, said manufacturer's computer being able to connect to said computer network through which connection can be made to said one or more host machines to access the CCP.

9. A system for enabling a second class of providers (SCP) to provide display objects (DO), comprised of one or more aspects, to selected groups or individuals of a first class of providers (FCP) over a computer network, the SCP to limit which of the aspects of the DO that may be altered by the FCP, and the FCP to selectively incorporate the DO into their own displays, comprising:
one or more host machines connected with said computer network;
a first control information and a first content information associated with each of said FCP and stored on said one or more host machines;
a second control information and a second content information associated with each of said SCP and stored on said one or more host machines;
a modification means to enter and/or modify the first control information, the first content information, the second control information, and the second content information;
a limiting means to limit the entry and/or modification of the individual first control information, the individual first content information, the individual second control information, and the individual second content information so that only the FCP or SCP to which the particular individual information is associated may enter or modify the individual information;
a discriminating means as part of the second control information for determining whether a particular FCP is allowed to display one or more aspects of a DO and which, if any, of the aspects can be modified by the FCP for use with the FCP's first content information;
a choosing means as part of the first control information for allowing a particular FCP to choose whether a DO of a particular SCP's second content information can be displayed along with the FCP's first content information; and
a display processor program (DPP) resident on said one or more host machines for receiving a request from one or more shoppers to display information from at least one of the FCP according to data stored in the first control information, the first content information, the second control information, and the second content information, the information displayed including information specified by the at least one of the FCP and further including a replicate of a display object specified by at least one of the SCP as qualified according to the first control information and the second control information.

10. The system of claim 9, wherein the modification means comprises:
a system control machine operatively connected to the one or more host machines, wherein said system control machine can be used to enter and/or modify any of the first control information, the first content information, the second control information, and the second content information.

11. The system of claim 9, wherein the modification means and the limiting means comprises:
a command console program (CCP) resident on said one or more host machines for allowing each of said FCP to enter and/or modify the first control information and the first content information that is associated with each of the FCP and each of said SCP to enter and/or modify the second control information and the second content information that is associated with each of said SCP.

12. An information display system comprising:
one or more host machines connected by a communication link;
a database stored on said one or more host machines;
information stored in the database, said information comprising categories characterized as a first control information and a first content information, which are associated with a first class of providers (FCP), and a second control information and a second content information, which are associated with a second class of providers (SCP), wherein each member of the FCP has individual first control information and individual first content information, and wherein each member of the SCP has individual second control information and individual second content information;
a modification means to enter and/or modify the first control information, the first content information, the second control information, and the second content information;
a limiting means to limit the entry and/or modification of the individual first control information, the individual first content information, the individual second control information, and the individual second content information so that only the FCP or SCP to which the particular individual information is associated may enter or modify the individual information; and
a display processor program (DPP) resident on said one or more host machines for receiving a request from one or more shoppers to display information from at least one of the FCP according to data stored in the first control information, the first content information, the second control information, and the second content information, the information displayed including information specified by the at least one of the FCP and further including information, which may include a replicate of a display object (DO), specified by at least one of the SCP as qualified according to the first control information and the second control information.

13. The system of claim 12, wherein the modification means comprises:
a system control machine operatively connected to the one or more host machines, wherein said system control machine can be used to access, enter and/or modify any of the first control information, the first content information, the second control information, and the second content information.

14. The system of claim 12, wherein the modification means and the limiting means comprises:
a command console program (CCP) resident on said one or more host machines for allowing each of said FCP to enter and/or modify the first control information and the first content information that is associated with each of the FCP and each of said SCP to enter and/or modify the second control information and the second content information that is associated with each of said SCP.

15. The system of claim 12, the modification means and the limiting means comprises:
a system control machine operatively connected to the one or more host machines, wherein said system control machine can be used to enter and/or modify any of the first control information, the first content information, the second control information, and the second content information; and
a command console program (CCP) resident on said one or more host machines for allowing each of said FCP to enter and/or modify the first control information and the first content information that is associated with each of the FCP and each of said SCP to enter and/or modify the second control information and the second content information that is associated with each of said SCP.

16. The system of claim 12, wherein templates are used to specify a layout for the information displayed, wherein the templates are filled in by the individual first and second content information specified in the database as directed by the individual first and second control information specified in the database.

17. The system of claim 16, wherein the templates comprise at least one FCP's template and at least one SCP's template, wherein the FCP's templates specify the layout for the portion of information displayed that comes from the first content information as directed by the first control information, and wherein the SCP's templates specify the layout for the portion of information displayed that comes from the second content information as directed by the second control information.

18. The system of claim 12, wherein the individual second control information comprises a discriminating means for determining whether a particular FCP is allowed to display a specific portion of the corresponding individual second content information.

19. The system of claim 18, wherein the discriminating means further determines what part, if any, of the specific portion of the corresponding individual second content information can be modified by the FCP for use with the FCP's individual first content and control information.

20. The system of claim 19, wherein the discriminating means comprises a set of inclusion rules and a set of exclusion rules, such that a particular FCP will be allowed to display the specific portion of the corresponding individual second content information if the inclusion rules associated with the specific portion permit the FCP to display the specific portion and the exclusion rules associated with the specific portion do not prohibit the FCP from displaying the specific portion.

21. The system of claim 20, wherein the individual first control information comprises a choosing means for allowing a particular FCP to choose whether a specific portion of a particular SCP's individual second content information can be displayed along with the FCP's individual first content and control information provided that the inclusion rules associated with the specific portion permit the FCP to display the specific portion and the exclusion rules associated with the specific portion do not prohibit the FCP from displaying the specific portion.

22. A method for using the system as described in claim 3, the method comprising the steps of:
entering and/or modifying a first control information and a first content information for a retailer in a database associated with one or more host machines;
entering and/or modifying a second control information and a second content information for a manufacturer in the database associated with one or more host machines;
a shopper accessing a retailer's address on the system over a computer network;
the shopper's accessing of retailer's address activating a display processor program (DPP) resident on said one or more host machines;
the DPP activating one or more templates resident on said one or more host machines to specify a layout for information that will be displayed for the shopper; and
information being displayed for the shopper according to the layout specified by the one or more templates, wherein the templates are filled in by the first content information associated with the retailer and the second content information associated with the manufacturer as directed by the first control information associated with the retailer and the second control information associated with the manufacturer, wherein the first control information associated with the retailer determines whether the manufacturer's information may be displayed along with the retailer's information and the second control information associated with the manufacturer determines whether the retailer may display the manufacturer's information and what part, if any, of the manufacturer's information may be modified by the retailer for display along with the retailer's information.

23. A method of facilitating the dissemination of information over a computer network between at least one shopper, at least one retailer, and at least one manufacturer using a system, the method comprising the steps of:
the shopper accessing a particular retailer's website, which is associated with one or more host machines on which are located templates and datasets, wherein a dataset is associated with each individual retailer and manufacturer represented in the system, wherein a dataset comprises content information and control information, and wherein each individual retailer and manufacturer represented in the system can input and modify the content information and the control information associated with that individual retailer or manufacturer;
the retailer's website accessing the one or more host machines, wherein one or more templates are activated to specify a layout for information that will be displayed for the shopper; and
information being displayed for the shopper according to the layout specified by the one or more templates, wherein the templates are filled in by the content information specified in the dataset associated with the retailer and in the dataset associated with the manufacturer as directed by the control information specified in the dataset associated with the retailer and in the dataset associated with the manufacturer, wherein the control information associated with the retailer determines whether a particular manufacturer's information may be displayed on the retailer's website and the control information associated with the manufacturer determines whether a particular retailer may display the manufacturer's information and what part, if any, of the manufacturer's information may be modified by the particular retailer.

24. A method for enabling members of a first class of providers (FCP) to provide display objects (DO) to selected members of a second class of providers (SCP), and for enabling the SCP to selectively incorporate the DO into their own displays, comprising the steps of:
setting up an individual access account for each FCP on a first server;
setting up an individual access account for each SCP on the first server or on a different server connected to the first server:
creating a dataset for each SCP, wherein the dataset comprises a second content information and a second control information, wherein the second content information comprises DO, and
wherein the second control information comprises a discriminating means for determining whether a particular FCP is allowed to display a specific portion of the second content information or a specific DO and what part, if any, of the specific portion of the second content information can be modified by the particular FCP; and
creating a dataset for each FCP, wherein the dataset comprises a first content information and a first control information, wherein the first content information comprises information about the FCP, and wherein the first control information comprises a choosing means for allowing a particular FCP to choose whether a specific portion of a particular SCP's second content information or DO can be displayed along with the particular FCP's first content information, provided that the discriminating means of the second control information associated with the specific portion of the particular SCP's second content information permits the particular FCP to display the specific portion.
